(19) United States
(12) Patent Application Publication
(10) Pub. No.: US 2010/0176620 A1
(43) Pub. Date: Jul. 15, 2010

(54) SELF-SUPPORTING BENCH ASSEMBLY FOR PERSONNEL TRANSPORT

(76) Inventor: JOHN MICHELI, Dearborn, MI (US)

Correspondence Address: KANE & CO., PLC, 29 PEARL ST. NW, 410 FEDERAL SQUARE BUILDING, GRAND RAPIDS, MI, 49503, US

(21) Appl. No.: 12/351,819

(22) Filed: Jan. 10, 2009

(51) Int. Cl. B60N 2/00

(52) U.S. Cl. 296/63

(57) ABSTRACT

A seating system for a vehicle having a cargo bed including a bench assembly for providing seating for personnel. The bench assembly includes a bottom frame assembly having opposing longitudinal edges and a plurality of slats attached to the bottom frame assembly to provide a platform for the seat slats. A back assembly is provided extending from one of the longitudinal edges of the bench assembly. A bracket assembly interconnects the back assembly to the bottom frame assembly. The bracket assembly includes an elongated slot portion and a latch portion permitting the back assembly to translate relative to the bench assembly and pivot relative to the bracket assembly to keep the back assembly erect in a first position and to be disposed in a non-supporting or second position when not in use. A plurality of leg assemblies are attached to the bottom frame assembly in a manner that permits them to be extended in a first position and retracted into a nested position within the bottom frame assembly in a second position so that the entire seating assembly may be stowed in a compact manner.

### STATEMENT REGARDING FEDERALLY SPONSORED RESEARCH OR DEVELOPMENT

This invention was not conceived or developed using any funding provided by the United States government, it agencies, or other governmental agency.

### BACKGROUND OF THE INVENTION

1. Field of the Invention

This invention relates to seating and cargo system for a vehicle. More specifically the invention relates to a self-supporting, foldable and stowable seating system for use in or out of a cargo bed of a transport vehicle, and particularly to a seating system for use by personnel in military or commercial transport vehicles.

2. Description of the Related Art

Historically many vehicles provided the dual purpose of transporting supplies and personnel such as troops and support personnel to and from the battlefield and other specified locations. Generally these vehicles include a large cargo bay or bed that was open and accessible for carrying containers. When needed to transport military personnel and troops, benches were fixed to the side walls of the cargo bay or truck bed. Traditionally the benches were wooden structures with the backs standing substantially vertically and permanently fastened to the side of the vehicle. The seats were hinged to the sidewalls so they could be folded upwardly to lie substantially flush against the bench back and make additional floor room for supplies and the like.

Over the years the type of seating used for transporting troops and military personnel has not changed dramatically. Virtually all variations involved a substantially straight back member fixed permanently to the perimeter wall of the truck cargo bed with a seat permanently fixed at a right angle relative to the back such as shown in the drawing figures, or permitted to fold up or down relative to the back to move the seat portion toward the cargo bay walls. To the best of the inventors knowledge military troop transport seating has virtually always been configured with the seat back and seat are at right angles, the seat heights are often too low and/or not sufficiently wide enough to ergonomically accommodate the majority of military personnel. These configurations make such seating extremely uncomfortable when traveling over long distances and that often lead to lower back infections, neck, and kidney injury. Moreover, the seating has not been removable for use off the vehicle during times of rest or when seating away from the vehicle is desired.

The prior art seating assemblies used in commercial or military personnel transport vehicles generally have the following unsatisfactory attributes. Most if not all are not self-supporting. That is that they must be attached to the vehicle in order to provide the seating in the desired configuration. As a result the seat backs are often parallel to a side of the vehicle, and are disposed at a ninety degree angle relative to the seating surface itself. Past seating configurations also only allow the seat to pivot downwardly supported by a truss member that can only secure the seat if it is supported by a fixed stop such as the side of the vehicle. Other disadvantages of past and present seating configurations include ergonomic inefficiencies. Most if not all seating surfaces are at the incorrect height above the truck or cargo bed. This results in the thighs of the occupants to be raised above the hips when the feet are flat on the floor, or that the occupant must splay the thighs in order to have them flat against the bench. When filled to capacity, and the occupants side-by-side, excessive pressure is applied to a limited area of the body, producing back and neck injuries, trauma to the kidneys and digestive system, and blood clots that can travel through the occupants circulatory system and result in death or sever injury. Other ergonomic factors include smaller than optimum seating depth. Most prior art benches are a maximum of fourteen inches in depth from front to back when the occupants are equipped with all of their provisions, there is insufficient room for the occupant to sit on the seating surface, forcing them to continually push toward the back of the seat to try to remain on the bench.

Another disadvantage associated with prior art bench and seating arrangements is one of storage. Given the modular and fixed nature of the prior art, the benches were either folded flat against the cargo bay walls or left in place. On a typical bench system, this often occupied more than eight cubic feet of storage space which could have been used for other supplies and equipment. These forms of seating configurations also dictated the orientation of the troops or personnel within the seating area. Benches and seating fastened to the sidewalls of the cargo bay required troops to face inwardly toward the middle line of the cargo bed. This “perimeter” form of seating is often inefficient when wanting to transport larger number of personnel between locations. Lastly, the prior art seating arrangements for use in military or commercial personnel transports are often not self-supporting. That is that the seating systems are often not removable from the vehicle so that they could be used as bed, litters, or seating for briefings and the like.

The disadvantages of the prior military personnel transport seating are overcome by the present invention. The stowable bench assembly described below offers an ergonomically correct bench configuration for use on and off the transport vehicle. The configuration and construction provides functional and comfortable seating that can be arranged in a number of different configurations in the back of the transport vehicle. The configuration and materials used in the construction of the self-supporting bench assembly permit the user to quickly breakdown or setup the bench assembly in the back of the transport. The bench assembly may also be easily removed from the vehicle and placed on the ground and used as conventional seating in briefing, meetings, or simple relaxation situations laying down for field medical procedures. When not in use the design and construction of the bench assembly allows the user to quickly break it down and stow it away in a number of locations on the vehicle. The same stowed configuration provides the most efficient use of storage space on the vehicle making it easy and efficient in military operations. The materials used in the construction of the stowable bench assembly make it rigid yet lightweight. Moreover the materials used in the construction of the bench assembly offer ballistic protection to the occupants. Such a lightweight, ergonomically correct seating assembly for military personnel will reduce the injury from transport related injuries such as blood clots and the like, as well as from ballistic projectiles traveling from under the seat or from behind the bench back. To the best of the inventor's knowledge or experience no other personnel seating product offers the same degree of flexibility or utility as the instant invention.

### BRIEF SUMMARY OF THE INVENTION

The present invention overcomes the disadvantages of the prior art in that it provides a novel seating system for use in a vehicle where the vehicle has a cabin at one end and a cargo bed at an opposite end. The cargo bed includes a floor section of predetermined area defined by a peripheral edge, and at least one wall section extending from the peripheral edge of the floor section. The bench assembly of the invention is designed for use in the cargo bay of the vehicle to provide seating for personnel. The bench assembly includes a bottom frame assembly having opposing longitudinal edges. Slats are attached to the bottom frame assembly to form a seating surface. A back assembly is attached to one of the longitudinal edges of the bench assembly to provide back support for the occupant. A bracket assembly interconnects the back assembly to the bottom frame assembly. The bracket assembly includes an elongated slot portion and a latch portion permitting the back assembly to translate relative to the bench assembly and bottom frame assembly and to pivot relative to the bracket assembly to stand erect in a first deployed position and to lie substantially parallel to and adjacent an upper surface of the bench assembly in a retracted and stored position.

In another form of the invention, the bracket assembly used to attach the back assembly to the bottom frame assembly is designed to permit the back assembly to translate vertically relative to the seating surface and then to pivot in a second direction so that the back assembly hangs vertically from the bracket in an inverted position,, leaving the seating surface entirely unobstructed for use as a litter or conventional bench.

According to another form of the invention, a latch portion of the bracket assembly is offset relative to the elongated slot portion to receive a flange of the back assembly and thereby keeping the back assembly in the erect and first deployed position. A plurality of leg assemblies are pivotally coupled to the bottom frame assembly at spaced intervals and are adapted to pivot between a first nested position within the bottom frame assembly and a second extended position substantially perpendicular to the bottom frame assembly to support the bench assembly a predetermined distance above the floor section of the cargo bed. The legs are maintained in the second extended position by a plurality of stay members attached to the bottom frame assembly, and each detachably coupled to a respective one of the plurality of leg assemblies. Legs are locked into place by one or more stay members per leg assembly creating a ridge perpendicular position of the leg assembly in the second extended position.

In yet another form of the invention, the bottom frame assembly, the plurality of leg assemblies, and the main supports for the back assembly are all made from the same type of material with universal fasteners so that repairs can be easily made and reducing the number of structural components, making the assembly less complicated and easy to repair. The members used to form the seating surface and the bulk of the back support assembly are likewise made from the same type of materials, preferably a pull-extruded fiber-reinforced polymer such as a fiber reinforced plastic wherein the fibers provide a ballistic characteristic to the material as well as making it strong and lightweight.

According to another form of the invention, the seating system further includes a range of universal mounting system in the vehicle cargo bed. In one form of the invention, it is envisioned that slots or recesses are formed in the floor section of the cargo bed in a shape and configuration to receive a lower end of each of the leg assemblies therein, anchoring the seating system within the vehicle and preventing the seating assembly from sliding back and forth and too-and-frow within the cargo bed. Additional anchoring systems include the use of cleats that can be attached by fasteners directly to the lower ends of the leg assemblies. Both anchoring systems permit quick and easy removal of the seating system from the vehicle cargo bed for use elsewhere in a free standing configuration.

In another form of the invention, the bottom frame assembly comprises at least two longitudinal members spaced from one another and generally parallel to one another, and extending substantially a length of the seating system. The longitudinal members are interconnected by a plurality of cross-members disposed at spaced intervals along the length. Fasteners are used to interconnect the longitudinal members to the cross-members to form the bottom frame assembly. The bottom frame assembly provides the basic mounting structure for receiving the plurality of slats that are attached to an upper surface of the bottom frame assembly and arranged substantially parallel to the longitudinal members. The bottom frame assembly is also the structure used for attaching the leg assembly and the backrest assembly via the backrest assembly bracket.

These and additional forms and advantages of the present invention will be apparent from a reading of the following detailed description of just one of many embodiments of the present invention, taken in conjunction with the appended drawing Figures, in which the same reference numeral will be used to refer to the same feature, or to features which are analogous in structure or function to one another.

### BRIEF DESCRIPTION OF THE DRAWING FIGURES

FIG. 1 is a schematic diagram of a vehicle to be used in association with the invention;

FIG. 2 is a schematic diagram of one form of transport seating;

FIG. 3 is a schematic diagram of another form of transport seating;

FIG. 4 is a schematic diagram of yet another form of transport seating;

FIG. 5 is an oblique view of a floor section of the vehicle shown in FIG. 1 illustrating one layout of the seating system of the invention;

FIG. 6 is a front elevation view of the seating system generally shown in FIG. 5;

FIG. 7 is an end elevation view of the seating system shown in FIG. 6;

FIG. 8 is a bottom view of the seating system shown in FIG. 6; and

FIG. 9 is a view of the bracket used to support the back of the bench assembly.

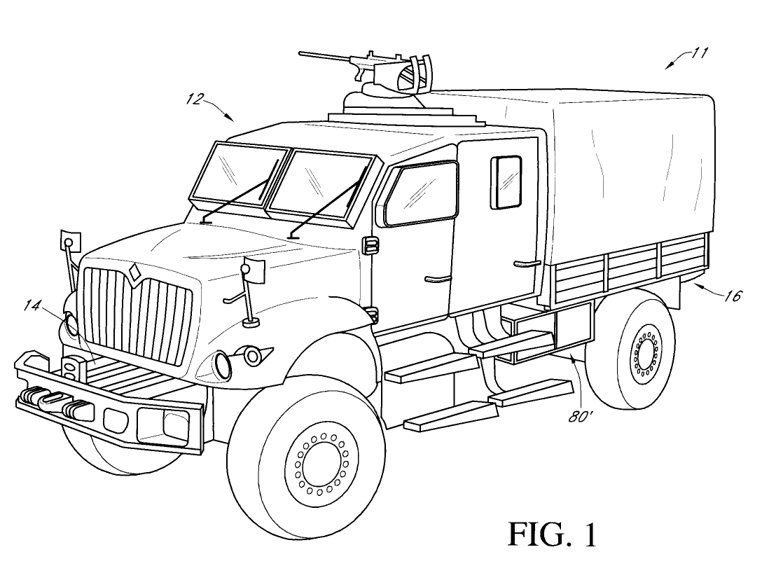

### DETAILED DESCRIPTION OF THE INVENTION

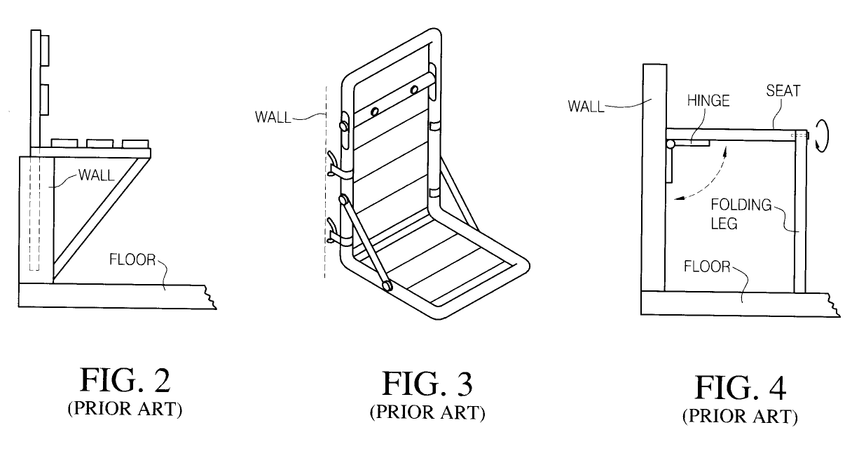

For purposes of description only, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Specific dimensions and other physical characteristics relating to the embodiments disclosed herein are not to be considered as limiting, unless the claims expressly state otherwise.

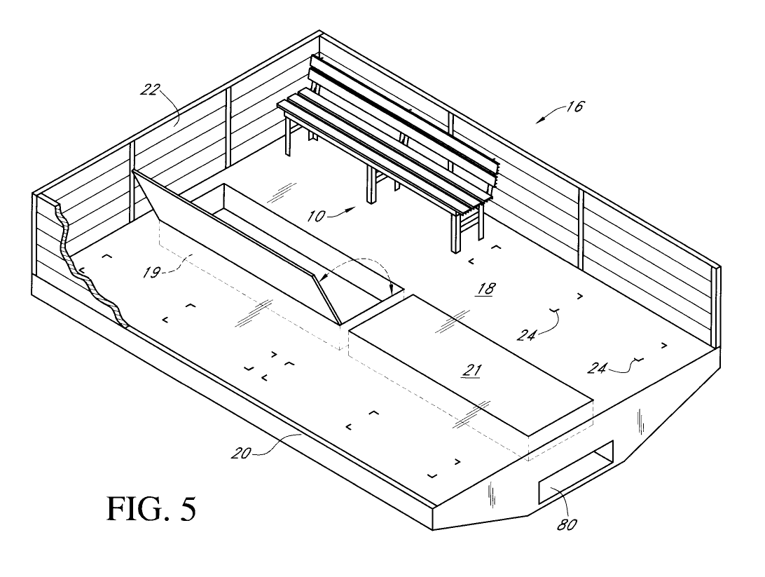

Prior bench designs for use in military transports often utilized a simple hinged bench attached to a back support such that the seat could fold up or down relative to the back. See FIGS. 2-3. Other versions of bench designs for military transports used a fixed bench position rigidly attached either to the floor of the vehicle or suspended from the sidewall. See FIG. 4. The disadvantage of such prior seating configurations is primarily one of poor ergonomics. The seat and back are often arranged at nearly a ninety-degree angle relative to one another when in use making it uncomfortable for the occupants when sitting for long periods of time. Moreover the bench assemblies cannot be used elsewhere because they rely upon a portion of the vehicle to provide seat support. That is to say that the bench assembly cannot be easily removed from the vehicle and used on the ground or elsewhere. These disadvantages are overcome by the invention described below.

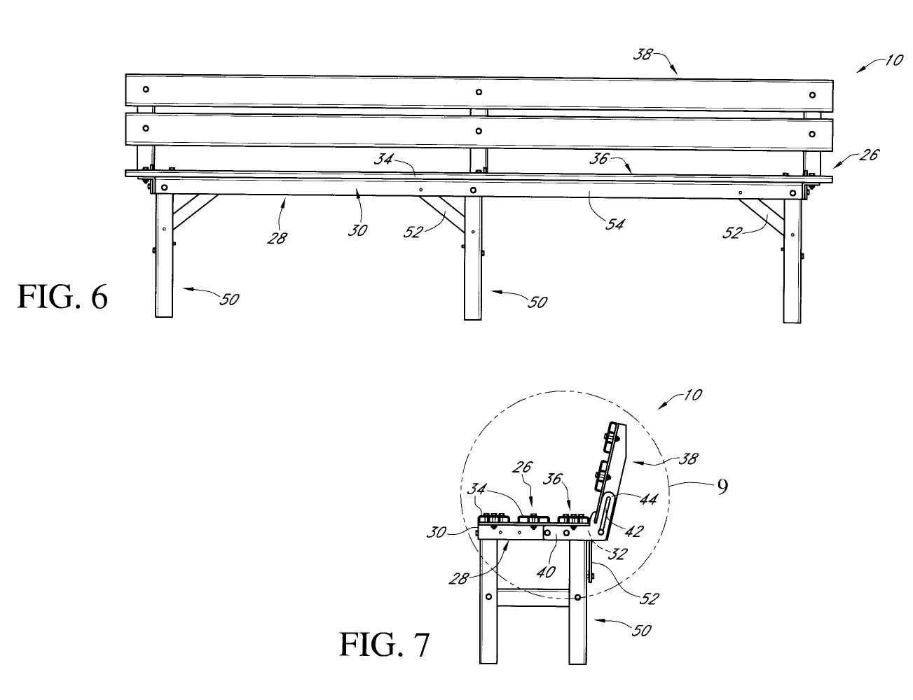

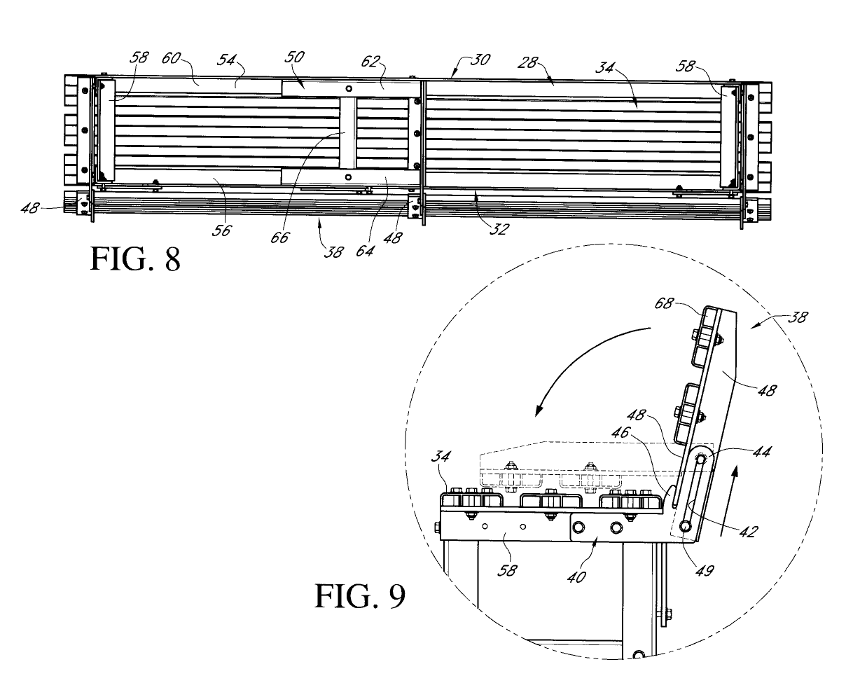

FIGS. 5-9 illustrate one embodiment of a seating system 10 for use in a vehicle 11 and in particular vehicles having multiple purposes including the transport of supplies as well as personnel. Vehicles of this type are most often used by the armed forces of the world but are also used by humanitarian agencies and organizations, the United States Department of Homeland Security, The United States National Guard, correctional facilities around the world, as well as commercial enterprises. Such vehicles 11 typically include a cabin 12 mounted to one end of a chassis 14. The cabin 12 may be of any desired size and contains the seat for the driver of the vehicle. The cabin may also accommodate other personnel that can provide offensive and defensive protection to the vehicle by means of a weapon system attached to the roof or to the side of the cabin.

Attached to the chassis 14 behind the cabin 12 is typically a cargo bed 16. The cargo bed 16 typically includes a floor section 18 which is either directly or indirectly attached to the chassis 14. The cargo bed 16 is generally of a predefined length and width defined by a peripheral edge 20 or panels or stakes such as used on commercial trucks, and may or may not have walls, depending upon the application. However in the embodiment shown, the cargo bed 16 includes walls identified by numeral 22 extending upwardly from the bed proximate the peripheral edge 20. The cargo bed walls 22 may be in the form of stake panels detachably mounted to the floor section or something more permanent such as metal walls welded to the cargo bed peripheral edge 20. In a preferred embodiment the cargo bed 16 includes at least one section of wall 22 extending from the peripheral edge 20 of the floor section 18.

The seating system 10 of the invention is designed to be easily deployed in the cargo bed 16 of the vehicle 11 when needed, and easily stowed in one of a number of locations on the vehicle when the vehicle is intended to haul cargo or other supplies. The seating system 10 can also be easily attached to the cargo bed 16 of the vehicle in a number of configurations depending-upon the desired orientation of the occupants, or upon the number of occupants. The floor section 18 of the cargo bed 16 may be readily adapted and fit with mechanisms for mounting the seating system 10 for rapid set up and take down. For example, a plurality of openings such as cut-outs or slots generally identified by numeral 24 may be cut or punched in the floor section 18 and designed to receive the legs or other components of the seating system 10 to prevent the seating system 10 from sliding on the floor section 18. Alternatively, the floor section 18 may be mounted with a frame or sole plate 19 that engages parts of the seating system to keep it in place, yet allow easy and quick removal for converting the space from personnel transport to cargo transport. It is also envisioned that the current invention may be mounted so that the seating assembly 10 can be removed from the cargo bed 16, folded and stowed in one or more storage bins or compartment generally designated by reference numeral 21 to provide a flush surface with the floor section 18. Each of the storage bins may be fitted with a hatch to close the storage bin. Those of ordinary skill in the art after considering the description of the leg assemblies provided below, will recognize how to adapt this invention for fitting within recesses in the cargo floor section 18 so that they fit flush in a stowed and retracted configuration. Simple compartments can be fabricated into or attached to the underside of the bed 18. These compartments are designed to store the benches when not in use and consist of rectangular box and a lid. When the benches are in use, these compartments can be used to store first aid equipment, tools, water, additional fuel, additional ammunition and other mission related items.

Referring to FIGS. 5-9, the seat assembly 10 is comprised of a bench assembly 26 for providing seating for personnel. The bench assembly 26 includes a bottom frame assembly 28 forming opposing longitudinal edges 30, 32 and a plurality of slats 34 attached to the bottom frame assembly 28 for forming a seating surface 36. A back assembly 38 runs parallel to one of the longitudinal edges 30, 32 of the bench assembly to support the backs of the users. The back assembly is maintained in an inclined orientation or position relative to a gravitational vertical line by a bracket assembly 40 interconnecting the back assembly 38 to the bench assembly 26. Ideally the back assembly is maintained in a deployed configuration at an angle between approximately five degrees and fifteen degrees, and most preferably at about twelve to thirteen degrees when the seat is substantially in a horizontal position. The bracket assembly 40 includes an elongated slot portion 42 formed in a tongue 44 of the bracket assembly 40 and a latch portion 46. A fastener generally referenced by numeral 48 extends through the elongated slot 42 to interconnect the back assembly to the bracket assembly in sliding engagement, permitting the back assembly 38 to translate in the direction of the slot 42 relative to the bench assembly 26 and pivot relative to the bracket assembly 40 to stand erect in a first deployed position and to either lie substantially parallel to and adjacent the seating surface 36 of the bench assembly 26 in a second position, or hang vertically from the bracket in a third position. The upright position of, the back assembly 38 relative to the bench assembly 26 is maintained by the latch portion 46 of the bracket assembly 40 receiving a flange of one of the back cross-members 48 disposed at the distal ends of the back assembly and interconnect the back assembly components.

The seating system 10 further comprises a plurality of leg assemblies 50 pivotally coupled to the bottom frame assembly 28 at spaced intervals and adapted to pivot between a first nested position within the bottom frame assembly 28 and a second extended position substantially perpendicular to the bottom frame assembly 28 to support the bench assembly a predetermined distance above the floor section 18 of the cargo bed 16. Each leg assembly 50 is maintained in the extended position by a respective stay member 52 attached at one end to the bottom frame assembly 28, and each detachably coupled at the opposite end to the respective one of the leg assemblies 50. Each stay helps to keep each leg assembly in the second extended position. The stay members 52 may be in anyone of a number of different mechanical configurations, the most rudimentary including one or more straps pivotally attached at one end to one of the leg assemblies or the bottom frame assembly, and the other end detachably coupled to the opposite member. Other systems may be used including spring tensioned latch pins, knobs or bolts may be used to secure each stay member 52.

In a preferred embodiment of the invention, it is desired to manufacture the seating assembly from a material that can easily be obtained in foreign theatres of operation either through cannibalism of like products or can be easily substituted for other materials. Toward that end the seat assembly of the invention uses a standard size of fastener in connecting all of the components. The uniformity in the type of fastener allows the user or operator to use fewer tools. Moreover, since the fasteners are universal, parts are easy to come by either through normal supply channels or by cannibalizing other seating assemblies that may have been damaged.

The materials used for building the seating assembly are also unique in that they are light weight, strong, and easily obtained and manufactured. In a preferred embodiment of the invention, each of the structural components of the seating assembly are preferably manufactured from fiber reinforced plastics or polymers, aka FRP. The FRP materials are also somewhat flexible, durable, and not prone to crack or splinter in harsh condition. This type of material may also be reinforced by strands or fibers that offer a ballistic characteristic to each of the members. Such strands include Kevlar, ballistic nylon, and the like that reduce penetration of objects. These types of fiber reinforced materials are resistant to weathering, corrosive chemicals, and contraction or expansion caused by heat.

In a preferred embodiment, the members forming the bottom frame assembly 28 are preferably made from one-quarter inch pull-truded fiber reinforced plastics in the form of a 2-inch-by-2 inch or greater angle in any desired length appropriate for the size of the seating assembly 10. These angle members may also be made from aluminum which is readily and commonly available. The bottom frame assembly 28 preferably includes two longitudinal members 54, 56 which extend substantially the length of the seating assembly, and interconnected at opposing ends and at least one intermediate section by shorter lengths of the same stock universally referenced by numeral 58. The manner in which the angled stock is assembled creates a recess 60 within the bottom frame assembly produced by the thickness of each flange of the angle stock. The substantially horizontally oriented flange of the bottom frame assembly stock provides a suitable platform for attaching the desired number of slats 34.

In the preferred form of the invention, the same dimension and type of stock is used to manufacture the leg assemblies. Each leg assembly 50 includes at least two supporting members 62, 64, each pivotally attached to a flange of a respective one of the longitudinal members 54, 56 and interconnected to one another by a cross member 66. This way each of the leg assemblies 50 is allowed to pivot relative to the bottom frame assembly between the nested position between the longitudinal members 54, 56 when in the stowed position.

Referring to the drawing figures, the back assembly 40 is also made from a plurality back slats 68 similar to those used to form the seating surface 36 of the bench assembly 26. Each of the back slats 68 are interconnected in parallel spaced relationship to one another by the plurality of back cross-members 48 mentioned earlier.

In operation of the invention, the seating systems are preferably stowed in a compartment such as 80 on the vehicle 11. Such a compartment may be defined extending along the length of the vehicle between the chassis beams or outboard of the chassis along the side of the vehicle. Other storage locations include under the cargo bed, on the side of the vehicle between the front and rear tires, in a sub-surface floor compartment formed in the floor portion of the cargo bed, or substantially any other area on the vehicle where a shelf or hanging rack can be mounted. Regardless of the desired storage location, each seating assembly 10 is pulled and the leg assemblies 50 extended from the nested and stowed position formed within the interior of the bottom frame assembly 28. The relative position of each leg assembly is fixed by attaching the stay member 52 interconnecting the bottom frame assembly 28 to an intermediate portion of each supporting member 62, 64. If it is desired to deploy the back assembly 38 the user simply rotates the back assembly upward about the pivot point formed by the fastener extending through the elongated slot 42 until the flange of the back cross members 48 align with the latch assembly. At that point the back assembly is translated downward along the elongated slot 42 until the flange of the back cross member engages the groove within the latch portion 46.

If it is desired to keep the seating assembly 10 relatively stable within the cargo bed 16, the operator simply needs to align the bottom ends of the supporting member 62, 64 to slide into the cut outs or slots formed in the floor section of the cargo bed. The depth to which each supporting member slides into each slot is controlled either through stops attached to each of the supporting member or by creating a wall in the bottom of each slot. Using this form of mounting method a number of slot configurations can be cut into the flooring section to accommodate a fixed number of bench deployment configurations. Other mounting options include straps, floor plates or other forms of anchors that can be used to interconnect the leg members to the floor portion 18-of the cargo bay 16.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents. The embodiments of the invention in which an exclusive property or privilege is claimed are defined below.

I claim as my invention:

1. A seating system for use in a vehicle having a cargo bed having a floor section defined by a peripheral edge, and at least one wall section extending from said peripheral edge of said floor section, the seating system comprising:
a bench assembly for placement in the cargo bed of the vehicle for providing seating for personnel, said bench assembly having a bottom frame assembly forming opposing longitudinal edges and a plurality of slats attached to said bottom frame assembly for forming a seating surface;
a back assembly extending from one of said longitudinal edges of said bench assembly; and
a bracket assembly interconnecting said back assembly to said bottom frame assembly; said bracket assembly having an elongated slot portion and a latch portion permitting said back assembly to translate relative to said bench assembly and pivot relative to said bracket assembly to stand erect in a first deployed position and to lie substantially parallel to and adjacent an upper surface of said bench assembly in a retracted and stored position.

2. The seating system as defined in claim 1, wherein said latch portion of said bracket assembly is offset relative to said elongated slot portion and receives a flange of said back assembly therein to stand said back assembly in said erect position in said first deployed position.

3. The seating system as defined in claim 2, further comprising:
a plurality of leg assemblies pivotally coupled to said bottom frame assembly at spaced intervals and adapted to pivot between a first nested position within said bottom frame assembly and a second extended position substantially perpendicular to said bottom frame assembly to support said bench assembly a predetermined distance above the floor section of said cargo bed; and
a plurality of stay members attached to said bottom frame assembly, and each detachably coupled to a respective one of said plurality of leg assemblies to keep each of said plurality of leg assemblies in said second extended position.

4. The seating system as defined in claim 2, wherein said bench assembly, said plurality of leg assemblies, and said back assembly are formed from a pull-extruded fiber reinforced polymer.

5. The seating system as defined in claim 2, further comprising slots formed in the floor section of the cargo bed to receive a lower end of each of said leg assemblies therein and anchoring the seating system within the vehicle.

6. The seating system as defined in claim 2, further comprising an anchoring system attached to the floor section of the cargo bed and configured to engage said plurality of leg assemblies extending from said bottom frame assembly keeping the seat assembly in the cargo bed.

7. The seating system as defined in claim 2, wherein said bottom frame assembly comprises:
at least two L-shaped longitudinal members spaced from one another, generally parallel to one another, and extending substantially a length of the seating system;
a plurality of cross-members interconnecting said L-shaped longitudinal members at spaced intervals along said length; and
fasteners interconnecting said L-shaped longitudinal members with said cross-members to form said bottom frame assembly.

8. The seating system as defined in claim 7, further comprising a plurality of slats attached to an upper surface of said bottom frame assembly and substantially parallel to said L-shaped longitudinal members.

9. The seating system as defined in claim 7, wherein said L-shaped longitudinal members and said cross-members are L-shaped.

10. A seating system for a cargo bed attached to a vehicle, the cargo bed having a first and second plurality of openings formed therein, comprising:
at least one storage bin attached to a lower surface of said cargo bed and accessible through a hatch covering the first plurality of openings formed in the cargo bed;
at least one bench assembly for placement on the cargo bed and received in the second plurality of openings for use on the vehicle, removable from the cargo bed for use off of the vehicle, and collapsible and stowable in said at least one storage bin when not in use, said bench assembly including a bottom frame assembly, a plurality of leg assemblies pivotally coupled to said bottom frame assembly at spaced intervals and adapted to pivot between a first position nested within said bottom frame assembly and a second extended position substantially perpendicular to said bottom frame assembly to support said bench assembly, a plurality of stay members attached to said bottom frame assembly and each detachably coupled to a respective one of said plurality of leg assemblies to keep each of said plurality of leg assemblies in said second extended position, a bracket assembly extending from said bottom frame assembly, said bracket assembly including an elongated slot portion and a latch portion, and a back assembly attached to said elongated slot portion of said bracket assembly, wherein said back assembly is permitted to translate within said elongated slot portion relative to said bench assembly with a portion received in said latch portion to stand in a first deployed position, translate and pivot relative to said bracket assembly to orient said back assembly substantially parallel to an upper surface of said bench assembly in a stowable configuration, and to permit said back assembly to pivot and hang from said bracket assembly in a different configuration.

11. The seating system as defined in claim 10, wherein said bench assembly and said back assembly are formed from a fiber reinforced polymer.

12. The seating system as defined in claim 11, wherein said fiber reinforced material is formed by extrusion.

13. The seating system as defined in claim 12, wherein said back assembly is inclined relative to said bench assembly when in said first deployed position.

14. The seating system as defined in claim 12, further comprising further an anchoring system on the cargo bed and configured to engage said plurality of leg assemblies extending from said bottom frame assembly keeping the seat assembly in the cargo bed.

15. A multi-purpose seating system for use in and out of a vehicle having a bed, comprising:
a bench assembly including a bottom frame assembly,
a plurality of leg assemblies pivotally coupled to said bottom frame assembly at spaced intervals and adapted to pivot between a first position nested within said bottom frame assembly and a second extended position substantially perpendicular to said bottom frame assembly to support said bench assembly,
a plurality of stay members attached to said bottom frame assembly and each detachably coupled to a respective one of said plurality of leg a assemblies to keep each of said plurality of leg assemblies in said second extended position,
a bracket assembly extending from said bottom frame assembly, said bracket assembly including an elongated slot portion and a latch portion, and
a back assembly attached to said elongated slot portion of said bracket assembly, wherein said back assembly is permitted to translate within said elongated slot portion relative to said bench assembly, said back assembly including a portion received in said latch portion to keep said back assembly in a first deployed and substantially upright configuration, translate and pivot relative to said bracket assembly to orient said back assembly substantially parallel to an upper surface of said bench assembly in a stowable configuration, and to translate and pivot relative to said bracket assembly to be suspended from said bracket assembly in a hanging configuration.
